(19) United States
(12) Patent Application Publication
(10) Pub. No.: US 2004/0254884 A1
(43) Pub. Date: Dec. 16, 2004

(54) Content catalog and application designer framework

(75) Inventors: Yaniv Haber, Hertzelia (IL); Dror Last, Jerusalem (IL); Boaz Sapir, Tel Aviv (IL); Barak Hershkovitz, Kfar Saba (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SAP Aktiengesellschaft, Walldorf (DE)

(21) Appl. No.: 10/742,593

(22) Filed: Dec. 18, 2003

Related U.S. Application Data
(60) Provisional application No. 60/435,440, filed on Dec. 20, 2002.
(60) Provisional application No. 60/435,622, filed on Dec. 20, 2002.

(51) Int. Cl. G06F 17/60

(52) U.S. Cl. 705/51

(57) ABSTRACT

An interface for accessing objects in one or more object repositories, wherein objects are associated with nodes in an object hierarchy and have object types, the interface comprising a tree panel for displaying at least a portion of the object hierarchy, an object panel for displaying an object interface, wherein at least one property of a current object is displayed, an editor for each of a plurality of object types, each editor including instructions for displaying of an edit panel within the object panel when an edit function is selected and a permission hierarchy indicating which users of a class of users have access to which objects of the object hierarchy, wherein the tree panel display is dependent for each user on which objects the user has permission to view.

### CROSS-REFERENCES TO RELATED APPLICATIONS

This application claims priority from co-pending U.S. Provisional Patent Application No. 60/435,440 entitled “Content Catalog” filed Dec. 20, 2002, and co-pending U.S. Provisional Patent Application No. 60/435,622 entitled “Application Designer Framework” filed Dec. 20, 2002, which are incorporated by reference herein for all purposes.

### FIELD OF THE INVENTION

The present invention relates to apparatus, methods and interfaces for entering objects in an application framework and interacting with those objects.

### BACKGROUND OF THE INVENTION

Computer applications that provide user interaction with data have become more complex, as many users expect graphical user interfaces, live data, data captured from disparate sources, etc.

One approach to this problem is to provide clients with separate windows for each application. This approach is limiting in that users often want to see various information together on a page. To this end, a number of providers have developed portal systems, wherein portal pages can be set up and customized for each user. However, as portal systems become more complex, easier methods of interacting and maintaining those portal systems will be expected from end users and administrators.

### BRIEF SUMMARY OF THE INVENTION

An interface for accessing objects in one or more object repositories, wherein objects are associated with nodes in an object hierarchy and have object types, the interface comprising a tree panel for displaying at least a portion of the object hierarchy, an object panel for displaying an object interface, wherein at least one property of a current object is displayed, an editor for each of a plurality of object types, each editor including instructions for displaying of an edit panel within the object panel when an edit function is selected and a permission hierarchy indicating which users of a class of users have access to which objects of the object hierarchy, wherein the tree panel display is dependent for each user on which objects the user has permission to view.

Other features and advantages of the invention will be apparent in view of the following detailed description and preferred embodiments.

### BRIEF DESCRIPTION OF THE DRAWINGS

FIG. 1 is a schematic diagram of a network wherein a plurality of client browsers interacts over network with a portal system.

FIG. 2 is a block diagram of components of one example of an enterprise portal system.

FIG. 3 is a schematic diagram showing some components of an enterprise portal system in greater detail.

FIG. 4 illustrates a tree structure for a set of portal objects;

FIG. 4A illustrates a portion of the tree structure;

FIG. 4B illustrates a role portion of the tree structure in greater detail;

FIG. 4C illustrates a view of the user interface corresponding to the role portion of the tree structure as shown in FIG. 4B.

FIG. 5 illustrates relationships between various objects that might be stored in a portal contents database.

FIG. 6 illustrates the differing effects between a link and an instance.

FIG. 7 is a block diagram of an application framework and content catalog in an overall system.

FIGS. 8A and 8B illustrate permissions models.

### DETAILED DESCRIPTION OF THE INVENTION

The present invention has many applications, as will be apparent after reading this disclosure. In describing an embodiment of an application framework and content catalog according to the present invention, only a few of the possible variations are described. Other applications and variations will be apparent to one of ordinary skill in the art, so the invention should not be construed as narrowly as the examples, but rather in accordance with the appended claims.

In embodiments of the present invention, a client-side framework is provided where multiple content objects of a Web application can be edited and communicate with each other. The environment includes an easy to use protocol so that any editor can be easily integrated into it. The environment supports standard actions such as open, close, save, refresh, etc. Editors can add their own customized actions. Editors can change their behavior based on requests sent to them from other editors that are active inside the framework.

In one implementation, the client-side system uses JavaScript eventing. Everything can be event driven and the framework defines a set of events of which editors need to be aware in order to function within the framework. The framework can be implemented by program code that handles dispatching of events among various editor modules and tracks open editor modules and wizard modules. The framework might also provide a user interface environment to support execution of editor and wizard modules. In some embodiments, the program code executes largely on a client side of a client-server architecture.

FIG. 1 illustrates a possible environment in which embodiments of the present invention might operate. As shown there, client browsers interact with a portal system over a network and the portal system provides an interface for users using the browsers to access data services, object repositories and the like.

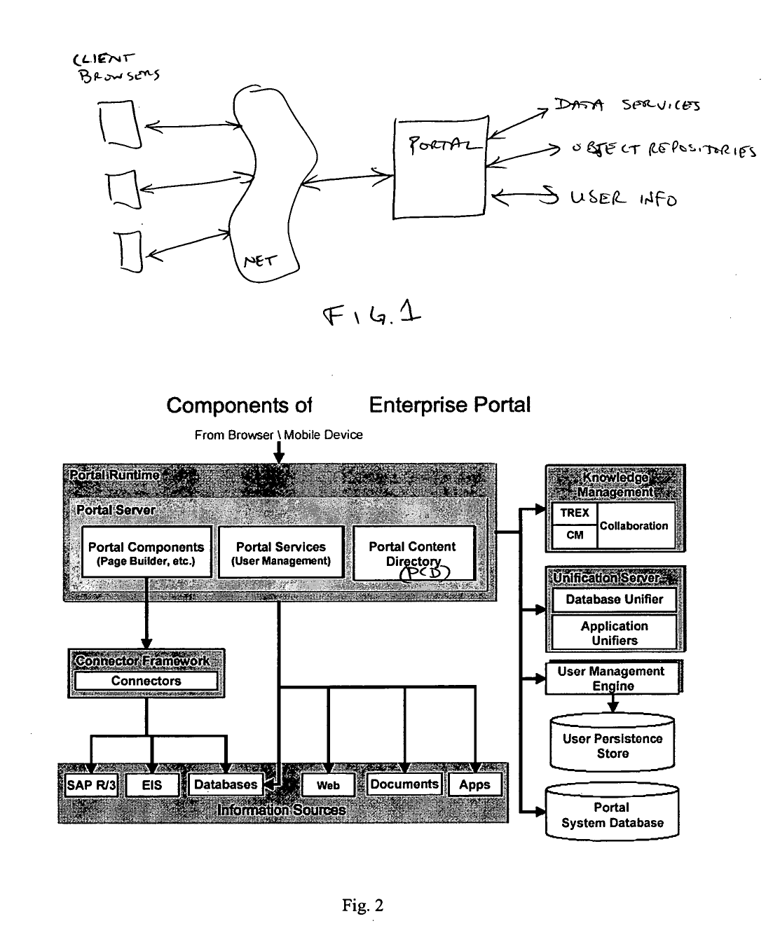

FIG. 2 illustrates some components in greater detail. As illustrated there, the client interacts with the portal system through a portal runtime that includes a portal server. The portal server interface is the end user's browser, mobile device, etc. to a variety of information sources. In addition to connection to information sources, the portal runtime also can interface to a knowledge management system, a unification server and the like. A repository can be used to store all or nearly all of the aspects of objects that might be needed to provide such interfaces. One example of a repository is SAP's Portal Content Directory.

Among other objects, the underlying repository might store application objects, connector service objects, templates, portal snippets, portal roles, portal pages and the like. Each object preferably has an associated type, a creation wizard for that object type and an editor for that object type. Templates might be used as the starting point for various other objects, such as portal snippets. One example of a portal snippet is SAP's iViews. Portal snippets can be arranged according to a layout on a page that forms part of a user's interface.

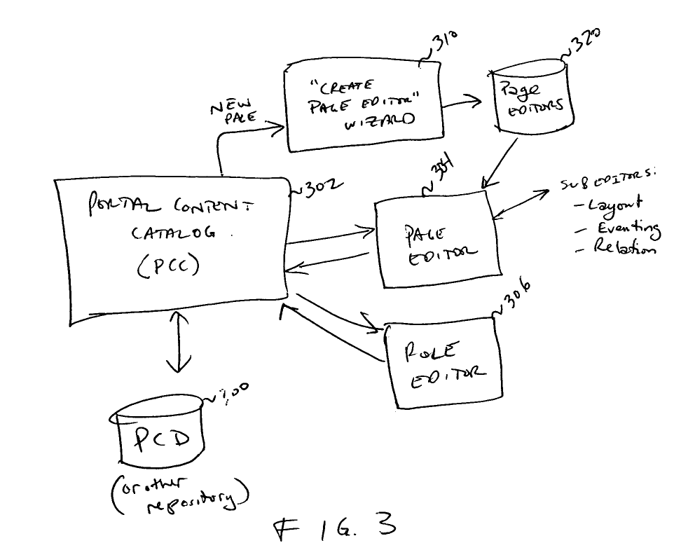

FIG. 3 illustrates one example of interactions usable to create content in the repository 300. As shown there, a portal content catalog (PCC) 302 might interact with a page editor 304 and/or a role editor 306. When a new page or other objects is to be created, PCC 302 can invoke a wizard 310 to create a page editor for the particular type of entity being created. PCC 302 can invoke a wizard to create the new object, e.g., a Page object. This new object can then be edited by an Editor object, i.e., a Page Editor.

As shown, pages are stored in storage 320, which might be in some embodiments included within repository 300. The repository is just one example for storage. In some embodiments, the portal content catalog might work over multiple repositories in a federated fashion.

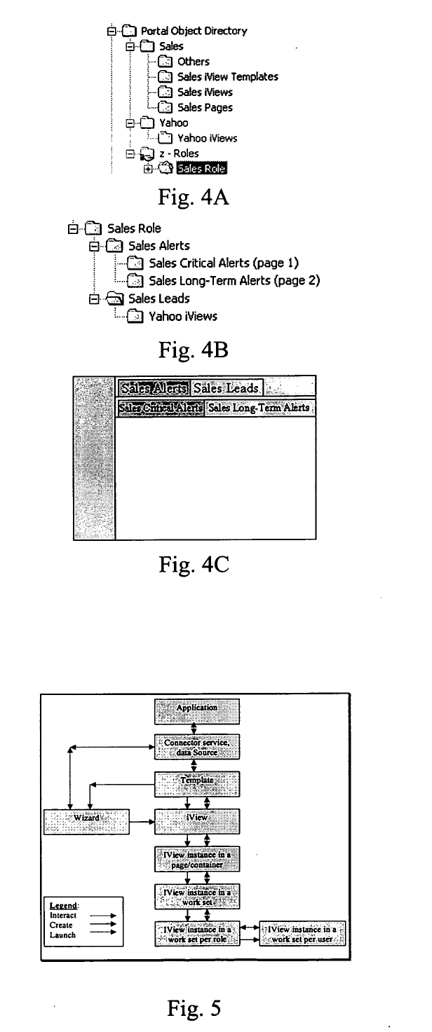

The objects in the repository can be stored in a hierarchical fashion. As an example, FIG. 4A illustrates a hierarchy of objects, such as templates, portal snippets, and pages. FIG. 4B illustrates a portion of the hierarchy of objects in greater detail organized under a particular role. FIG. 4C illustrates a user interface in view of the structure shown in FIG. 4B. Note that child objects in the tree structure of FIG. 4B are represented in FIG. 4C as tabs within tabs. While the role hierarchy is illustrated as being part of the main hierarchy, that need not be the case. The internal structure of a role might be presented in a role editor.

The repository thus forms a directory structure and can be considered the root node of the directory structure. A default set of objects might be included in a basic installation, with a facility to add additional objects using the portal content catalog. In order to control access to objects and editability of the directory structure, a permissions hierarchy can be overlaid on the directory structure.

Permissions are granted to groups, users and/or roles. Users might be identified by user parameters, login IDs, or the like when the user accesses the portal system. A user database might indicate further information about each user and might associate users into groups and assign roles to users. For example, all employees in a sales department might be grouped under a group named “Sales” and each user and/or group that is to develop content might be assigned a role of “Content Developer” or “Administrator”.

In one aspect of the present invention, permissions are also hierarchical in nature. Thus, a user with administrator access to a subtree of the directory structure might be able to grant others (users, groups, roles) permission to access objects in that subtree but would not necessarily be able to grant others permission to access objects above or aside that subtree.

Where a particular user (for example, a content administrator responsible for some part of the content) does not have read access to an object, that object does not appear in that user's version of the user interface. If a user has content creation capabilities, that user will have write access to some nodes in the repository. When the user, throughout their navigations, decides to create a new page or a new portal snippet, the new entities will be saved in a node of the repository to which they have write access.

Permissions can be hierarchically inherited, wherein a permission that is assigned to a parent object is inherited by all descendent of objects. Inheritance can be by default or global. If an editor indicates that a permission is to be inherited, it can carry over to each of the descendent nodes. The editor can indicate whether the inheritance is to be by default or global. With default inheritance, the descendent nodes inherit permissions only as to permissions that are not explicitly set for the descendent nodes, or is to be global, wherein the change causes each descendent nodes to “reset and inherit” permissions.

An object inherits its permissions from its parent object, unless it has its own explicitly set permissions. It is possible to clear all explicitly set permissions of all objects that are descendents of a given object and make them inherit permissions from this given object (“global” inheritance).

The origin of the parent object where the permissions came from should be remembered by the descendent node. Content developers will usually access the repository to build new content for their portal. Of course, they will only be able to see and create certain content, due to their security privileges.

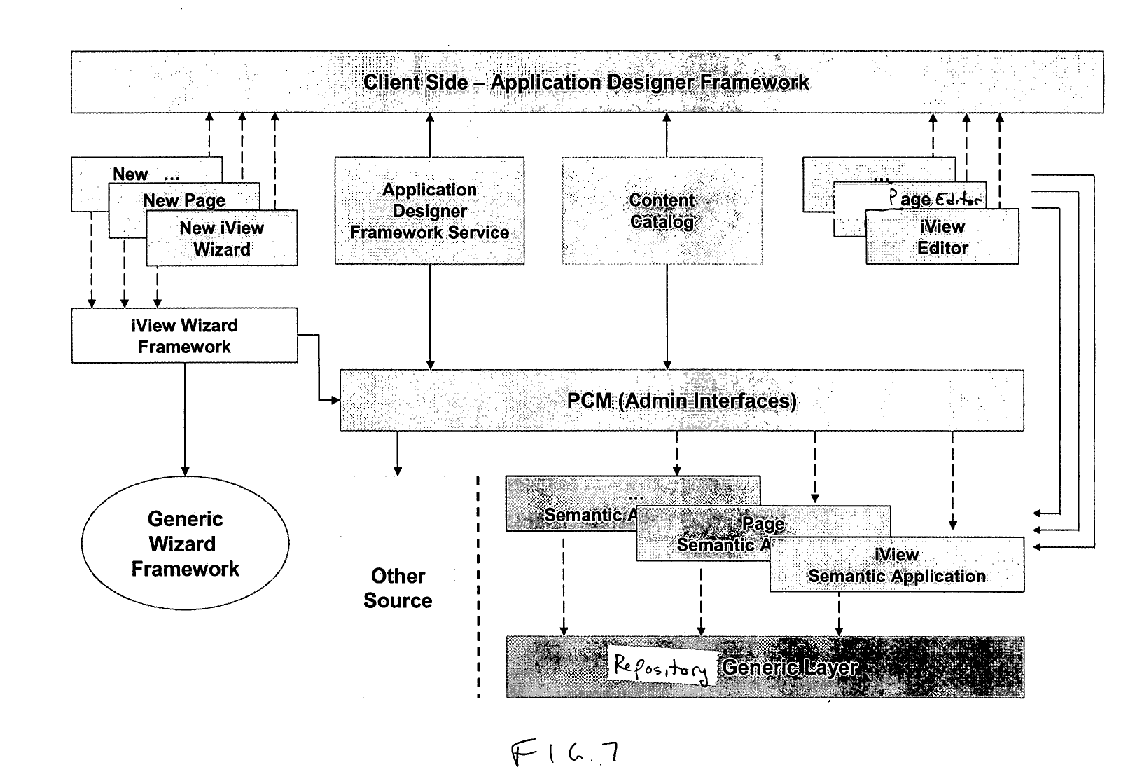

Examples of hierarchies are shown in FIGS. 8A (Administrator Mode) and 8B (End-User Mode). Examples of permissions that might be granted on an object or a subtree of objects in Administrator Mode include:

“Owner”—Every object has at least one owner. The owner has full control permission in addition to the ability to grant permissions to others, and add/remove owners.

“Full-Control”—Implies all the permissions below and the ability to delete object.

“Read/Write”—Ability to view an object, modify it (properties), create other objects inside it—without being able to delete the object. (Aggregation of “Read” and “Write” permissions).

“Write”—Ability to create an object in a container object without being able to see the container object and its properties, or to delete it. The newly created object cannot be modified after being created in the container object. “Write” permission might be used for end-user content creation and sharing. All users have a shared folder, through which other users can share content with them. On this folder, the “Every Users” group will be granted with “Write” permissions, in order to enable the group members (that have “sharing tools”) to write the shared content to it. Since the folder permissions are inherited to the objects in it, the “Every Users” group will get automatically Write permissions to all the shared content in the folder, including content that wasn't created/shared by the owner. This can be worked around as set forth below.

“Read”—The ability to view the object, copy it, create a link to it (either within the catalog or by adding it to a container type object, as a role).

Examples of permissions that might be granted on an object or a subtree of objects in End-User Mode include:

“End-User-Read”—The ability to view the object, read its properties and personalize them. In the user interface, possibly only the properties that were set for personalization would be visible. With page personalization, only users that have “End-User-Read” permission would be able to see the objects. As a result, if a user has “Full-Control” permission on portal snippet A but no “End-User-Read” permission for that portal snippet, the portal snippet will not appear in a page personalization display. Objects for which the user has only “End-User-Read” permissions, without administrative permissions, will not appear in the content administration environment.

Ownership is inherited from the container objects in which the object resides, as illustrated in FIG. 8B. The user that created the object within the container object is not necessarily the owner—that user just inherits the permission that the user has on the container. Permissions are checked on the specific object level, as illustrated by the rules shown to the right of objects in FIG. 8B. Thus, suppose that for folder F1, user U1 has “Full-Control” permission and for page P1 in folder F1, user U1 has “Read” permission. User U1 cannot delete page P1, since user U1 has only “Read” permissions on it.

In a folder hierarchy F1->F2->F3, if a user has to have “Write” access to a folder F3, he/she does not require any permission on folder F1 or F2. If a user has to have “Read” access for F3, he has to have at least “Read” permission on F1 and F2 in order to reach F3 in the portal catalog.

When trying to delete a folder with contents, before starting the deletion, the permissions of all the sub-tree objects should be checked. If the user does not have “Full-Control” permissions for a certain not object, the object will not be deleted, as well as the folders in the object's path. When user U1 tries to delete folder F1, user U1 will get a message saying that some of the objects cannot be deleted because of insufficient permissions. The user will be able to cancel or continue deleting the objects for which he has permissions. In this example, if the user continues the deletion, only P1 will be deleted.

The object editors (Page Editor, Role Editor, ACL Editor, etc.) implement a read-only mode, so that these editors can be used with objects with “Read” permission only; the editors then open such objects in the read-only mode.

By default, the Super-Admin role should be the owner of all the objects in the repository. It means that users assigned to this role can perform all the administrative operations on objects (“Owner” permission), but by default they cannot see the object at run time (as they do not have “End-User-Read” permission by default.

Permissions and administration can be delegated. For example, some users might be given full control over the root level of the repository and others might be given full control over only a subtree of the repository. A user with full control over some part of the tree can grant full control permissions to other users over a subset of that part of the tree. For example, suppose a user X has full control over node A having two child nodes B and C. User X can grant user Y full control of node B and grant user Z full control of node C. Following that grant, user Y can grant user W editing permissions on node B or on a child of node B.

Object Creation

Users with sufficient permission to create objects can do so. For example, a user could create a new portal snippet, a new template, a new page, a new folder and/or import a set of objects. Objects might have a chain of implementation, wherein a template serves as a “source” for objects that the content developer will create and some objects depend from implementations of other objects. Some of these dependencies can be links, while others are instances. FIG. 5 illustrates one possible relationship among various objects.

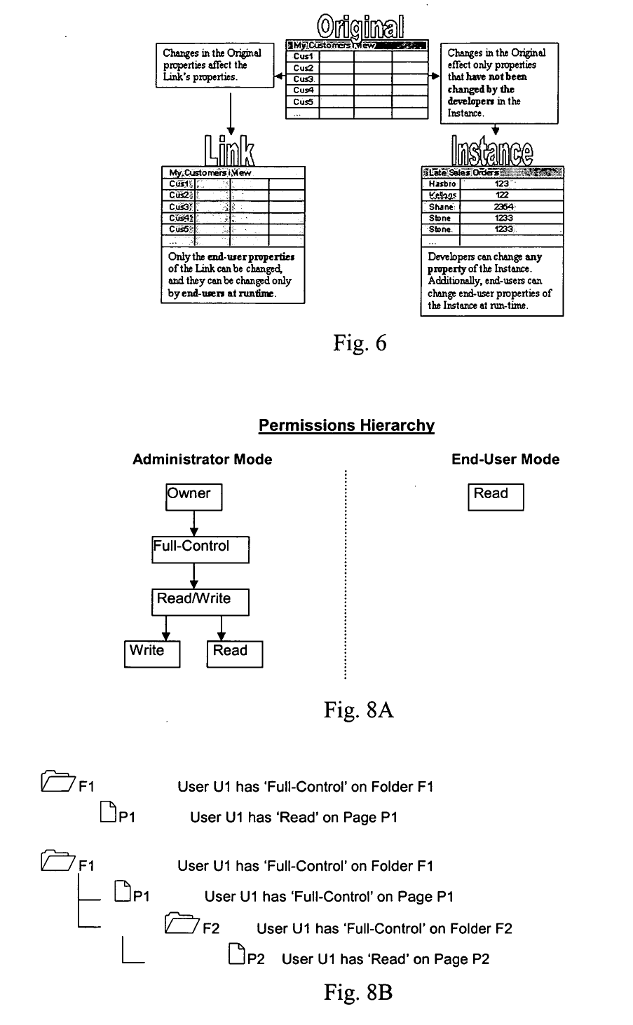

Rather than always creating new objects, a content developer have dependent implementations, where a child object depends on a parent object for its implementation or part of its implementation. The child object can be a link, wherein any later changes to the parent object are reflected in that child object, or the child object can be an instance of the parent object. With a link, a user is limited in the changes that can be made. If changes are desired, they would be made at the parent object instead. In the case of instances, changes can be more easily made to the child instance as the child instance is distinct from the parent instance, unless the change is to a permission or property that propagates through to the child instance and that permission or property is not set specifically for the child instance. FIG. 6 illustrates differences between links and instances.

Browsing

The PCC supports a browsing mechanism that allows a user to step through the different levels of the object hierarchy. Objects can have different icons depending on their type and might also include indicators of status and states.

Application Designer

An application can be designed using various tools described here and the objects needed to form an application can be stored in the repository. In one implementation, an application designer (“AD”) is a content development environment and its framework sets rules of interaction between different components that participate in this environment. Editors and components working inside the AD are influenced and communicate to one another using the framework eventing. This framework is also responsible for some administrative tasks such as arranging multiple open editors, etc.

The AD can run as an object itself, such as a portal page with isolated portal snippets. This is useful since the different editors and components running in it may be very different from each other with different HTML needs (JavaScript, Styling) and may come from different servers (an editor for content which is not from the portal itself). This is also useful for performance reasons: in such an extensive environment, rendering the entire page all over again does not make sense. Since portal snippets are isolated, each of them is retrieving data from a server on a different request, making possible databag communication.

Another task is to manage different editors open at the same time so that a content developer may be able to edit a page and a portal snippet and a role at the same time. One would be able to open as many instances of any editor as would be permitted by a pre-configured administrator limit. The framework will provide a component that handles the different editors and hides them when necessary in hidden frames. Others tasks might include sending “save”, “close”, “open” and other notifications to open editors and switching between open editors.

Objects such as editors might operate within the framework using event triggers. An editing process might begin with client-side software (e.g., JavaScript code) receiving an “open editor” request from the content catalog and opening the requested object editor.

When this event is raised, the framework code would create a new tab with iFrame(s) that will contain the requested editor (and optionally a property editor). The object ID is appended as a parameter to the URL so that the editor will open with the requested object.

Defined Events/Framework Events

The following sections describe various events that might occur within a framework. Additional parameters might be included in various events, to be delivered to the editor. These can be in the form of “Param1=val1&param2=val2& . . . paramN=valN” and are preferably encoded as valid URLs (avoiding an ‘&’ character or other special characters in values from being interpreted as part of the URL). The entire parameter string should preferably be encoded as well.

openEditorWithUrl Event

This event is raised by the different editors to ask to open a new tab with a certain editor and object. The framework will supply this editor's instance with a unique ID of the new opened tab, for further communication. In some implementations, only one instance of each editor can be open at a time, in which case this event would not be available.

| Arguments | Description |
|---|---|
| Editor URL | The URL of the editor to be opened. This should |
| | preferably be a repository location of the editor |
| | iView (e.g. pcd:portal_content/ |
| | admin.templates/editors/com.sap.portalpageEditor) or a |
| | Portal Component (com.sap.portal.pageEditor.default) |
| Object ID | The newly requested object ID to be open for edit. |
| Show Property | A Boolean indicator whether to open the property |
| Editor | editor or not. |
| Show Buttons | Optional parameter set by default to true. Decide |
| Toolbar | whether to display the buttons strip on the |
| | editor tab. Useful mostly for wizards. |
| Dynamic Buttons | Optional parameter. The URL of the editor's specific |
| URL | buttons component, in case the bShowButtonToolbar is |
| | true. |
| Display Name | The name that should be displayed on the tab. |
| Embedded Editor | Optional parameter set by default to false. Specifies |
| | whether to open the editor in an embedded mode. |

As an example, the following event will open a page editor with “myOwnPage” and open a property editor area beside the page editor:

EPCM.raiseEvent(“urn:com.sapportals.appdesigner:framework”,
“openEditorWithUrl”,
“/irj/servlet/prt/portal/prtroot/PageEditor.default;
/pcd/pages/myOwnPage;true”);

When this event is raised, the framework code would create a new tab with iFrame(s) that will contain the requested editor (and optionally a property editor). The object ID will be appended as a parameter to the URL so that the editor will open with the requested object. The URL to be launched in the above example is:

/irj/servlet/prt/portal/prtroot/PageEditor.default?objectID=
/pcd/pages/page1&editorID=<frameworkGeneratedID>

openEditorWithObjectId Event

This event is raised by the different editors to ask to open a new tab with a certain object. The framework will retrieve information about the editor's URL and the mode of display from the repository. The framework will supply this editor's instance with a unique ID of the new opened tab, for further communication.

| Arguments | Description |
|---|---|
| ObjectID | The newly requested object ID to be open for edit. |
| DisplayName | The name that should be displayed on the tab. |
| bEmbeddedEditor | Optional parameter set by default to false. |
| | Specifies whether to open the object in an embedded |
| | tab. |

As an example, the following event will open a page editor with “myOwnPage”:

EPCM.raiseEvent( “urn:com.sapportals.appdesigner:framework”,
“openEditorWithObjectId”, “/pcd/pages/myOwnPage”);

When this event is raised, the framework is responsible for creating a new tab with iFrame(s) that will contain the appropriate editor, according to the information inside the repository regarding the requested object. Additional parameters might also be included.

replaceEditorWithUrl Event

This event is raised by the different editors to ask to close the current editor in focus, and open a new tab with a certain editor and object. The framework will supply this editor's instance with a unique ID of the new opened tab, for further communication.

| Arguments | Description |
|---|---|
| EditorURL | The URL of the editor to be opened. If empty, |
| | do not open any new tab, just close |
| | the one in focus. |
| ObjectID | The newly requested object ID |
| | to be open for edit. |
| bShowPropEditor | A Boolean indicator whether to open the |
| | property editor or not. |
| bShowButtonToolbar | Optional parameter set by default to true. |
| | Decide whether to display the buttons strip on the |
| | editor tab. Useful mostly for wizards. |
| DynamicButtonsURL | Optional parameter. The URL of the editor's |
| | specific buttons component, in case the |
| | bShowButtonToolbar is true. |
| DisplayName | The name that should be displayed on the tab. |
| EditorId | The unique ID of the editor that is to be replaced |

Example: close the tab in focus, and open the page editor with “myOwnPage” and the property editor beside it:

EPCM.raiseEvent( “urn:com.sapportals.appdesigner:framework”,
“replaceEditorWithUrl”,
“/irj/servlet/prt/portal/prtroot/PageEditor.default;/pcd/pages/
myOwnPage;true;false;;MyOwnPage;” + myEditorID);

When this event is raised, the framework code would create a new tab with iFrame(s) that will contain the requested editor (and optionally a property editor). The object ID will be appended as a parameter to the URL so that the editor will open with the requested object. The URL to be launched in the above example is:

/irj/servlet/prt/portal/prtroot/PageEditor.default?objectID=/pcd/pages/page1&editorID=<frameworkGeneratedID>

replaceEditorWithObjectId Event

This event is raised by the different editors to ask to close the current editor in focus, and open a new tab with a certain object. The framework will retrieve information about the mode of display from the repository. The framework will supply this editor's instance with a unique ID of the new opened tab, for further communication.

| Arguments | Description |
|---|---|
| ObjectID | The newly requested object ID to be open for edit. |
| | If empty, do not open any new tab, just |
| | close the one in focus. |
| DisplayName | The name that should be displayed on the tab. |
| EditorId | The unique ID of the editor that is to be replaced |

Example: close the tab in focus, and open the page editor with “myOwnPage”:

EPCM.raiseEvent( “urn:com.sapportals.appdesigner:framework”,
“replaceEditorWithObjectId”, “/pcd/pages/myOwnPage;
MyOwnPage;” + myEditorID);

When this event is raised, the framework code would create a new tab with iFrame(s) that will contain the appropriate editor, according to the information inside the repository regarding the requested object.

beforeSave Event

This event is raised by the framework to signal an editor of the user's intention of closing it or moving to a different tab. In this case the editor needs to calculate whether a save operation is needed or not. The framework will wait for an “alertSave” event or a “saveDone” event (see definition below) event to be raised by the editor, before continuing with the operation. After a certain timeout with no response, the framework will prompt the user that the editor is not responding and that he may lose any changes.

Every editor should subscribe to this event. This event passes one argument to signal what will happen to the editor after the save action completes (as the behavior may be different in case the editor is about to be closed). The namespace used is unique per editor since each one is using their own ID and therefore this event should only be handled by one specific editor.

| Arguments | Description |
|---|---|
| Editor next status | An integer value, which indicates what is |
| | about to happen to the editor after the save operation. |
| | The options are: |
| | 0 - editor will be closed |
| | 1 - editor will lose focus |
| | 2 - editor will stay in focus |

As an example, and editor might subscribe to this event using the following:

EPCM.subscribeEvent(“urn:com.sapportals.appdesigner:” +
myEditorID, “beforeSave”, mySaveHandler);

The framework will raise the following event on a user “close” request for that editor:

EPCM.raiseEvent(“urn:com.sapportals.appdesigner:editorID”, “beforeSave”, 0);

alertSave Event

This event is raised by the different editors to signal that the user has changed data and to ask the framework to ask the user the “do you want to save your changes or lose data?” question. The framework will be the only component that has to implement this dialog.

The namespace used in this event raised will be the framework namespace and the parameters passed will describe the editor. The framework will always listen on this event in case editor want to force save operations.

| Arguments | Description |
|---|---|
| Editor namespace | The namespace of the editor being saved. |
| | This will be used to notify the editor of the user's |
| | choice in the dialog (save, don't save). |
| Display name | Used in the save dialog. |

saveContent Event

This event is raised by the framework to signal open editors to save the data. This is triggered after the user have chosen to save his changes from the save dialog or the save button. The namespace used in this event will be the editor ID. All editors should subscribe to this event.

| Arguments | Description |
|---|---|
| Editor next status | An integer value that indicates what |
| | is about to happen to the editor after |
| | the save operation. |
| | The options are: |
| | 0 - editor will be closed |
| | 1 - editor will lose focus |
| | 2 - editor will stay in focus |

As an example, an editor subscribes to the event as follows:

EPCM.subscribeEvent(“urn:com.sapportals.appdesigner:” +
myEditorID, “saveContent”, mySaveContentHandler);

The framework will raise the following event when a user clicks the “save” button:

EPCM.raiseEvent(“urn:com.sapportals.appdesigner:editorID”,
“saveContent”, “2”);

doNotSaveContent Event

This event is raised by the framework to signal open editors not to save the data, but to refresh the original data from the persistence. This is triggered after the user have chosen not to save his changes from the save dialog. The namespace used in this event will be the editor ID. All editors should subscribe to this event.

| Arguments | Description |
|---|---|
| Editor next status | An integer value, which indicates |
| | what is about to happen to the editor after |
| | the save dialog box closes. The options are: |
| | 0 - editor will be closed |
| | 1 - editor will lose focus |
| | 2 - editor will stay in focus |

Example: An editor subscribing to the event:

EPCM.subscribeEvent(“urn:com.sapportals.appdesigner:”+myEditorID, “doNotSaveContent”, myDoNotSaveContentHandler);

The framework will raise the following event when a user clicks the “close” button, and chooses not to save his or her changes:

EPCM.raiseEvent(“urn:com.sapportals.appdesigner:editorID”,
“doNotSaveContent”, “0”);

saveDone Event

This event is raised by an editor to mark that the save operation is complete. The arguments will describe the result of the operation. The namespace used in this event is the framework's namespace.

| Arguments | Description |
|---|---|
| Display name | Used in the save result notification dialog. |
| Result | Empty string if the action was successful. |
| | Any other string would be presented to the user |
| | as an error description. |
| Display result | Booloean to determine whether to display |
| | the save result or not. |

preview Event

This event is raised by the framework to mark that the preview button/menu item was clicked. The namespace used in this event will be the editor ID.

reset Event

This event is raised by the framework to mark that the Refresh button/menu item was clicked. The namespace used in this event will be the editor ID.

editMode Event

This event is raised by the framework to mark that the Edit Mode button/menu item was clicked. The namespace used in this event will be the editor ID.

edit Event

This event is raised by the framework to mark that the edit button/menu item was clicked. The namespace used in this event will be the editor ID.

alertMessage Event

This event is raised by the different editors to ask the framework to alert a message to the user. The namespace used in this event is the framework's. Some implementations of this message can use a modal dialog but it might also be done so that all messages will be displayed in one framework message bar.

| Arguments | Description |
|---|---|
| Message | The string to be presented in the message box. |
| Level | The severity of the message. 0 for information, 1 for |
| | warning, 2 for error. The default value is information. |

alertQuestion Event

This event is raised by the different editors to ask the framework to alert a question to the user. The framework will prompt the user with the requested question, when the user will be able to choose between: Yes, No or Cancel. The Cancel choice is optional and is a parameter to the event. The framework will raise the “questionResult” event with the option that was chosen by the user. The namespace used in this event is the framework's.

| Arguments | Description |
|---|---|
| Message | The string to be presented in the message box. |
| ShowCancelBtn | Boolean to determine whether to display |
| | the Cancel button or not (should be true/false) |
| EditorId | The unique ID of the editor that raises the question |

questionResult Event

This event is raised by the framework as a response to the alertQuestion event, to mark to the editor, currently in focus, on which button the user pressed. The namespace used in this event will be the editor ID.

| Arguments | Description |
|---|---|
| result | The result of the question that was prompted |
| | to the user. The options are: “Yes”, “No”, |
| | “Cancel”. |

disableSave Event

This event is raised by the different editors to ask the framework to disable/enable their “Save” button. This button is enabled by default. The namespace used in this event is the editor ID.

| Arguments | Description |
|---|---|
| Flag | A Boolean indicating whether to disable or to |
| | enable the Save button (“true” for disabling, |
| | “false” for enabling) |

Example: disable the editor's Save button:

EPCM.raiseEvent( “urn:com.sapportals.appdesigner:” + myEditorID,
“disableSave”, “true”);

disablePreview Event

This event is raised by the different editors to ask the framework to disable/enable their “Preview” button. This button is enabled by default. The namespace used in this event is the editor ID.

| Arguments | Description |
|---|---|
| Flag | A Boolean indicating whether to disable or to enable the |
| | Preview button (“true” for disabling, “false” for enabling) |

Example: disable the editor's Preview button:

EPCM.raiseEvent( “urn:com.sapportals.appdesigner:” + myEditorID,
“disablePreview”, “true”);

disableRefresh Event

This event is raised by the different editors to ask the framework to disable/enable their “Refresh” button. This button is enabled by default. The namespace used in this event is the editor ID.

| Arguments | Description |
|---|---|
| Flag | A Boolean indicating whether to disable |
| | or to enable the Refresh button (“true” for |
| | disabling, “false” for enabling) |

Example: enable the editor's Refresh button:

EPCM.raiseEvent( “urn:com.sapportals.appdesigner:” + myEditorID,
“disableRefresh”, “false”);

disableEditMode Event

This event is raised by the different editors to ask the framework to disable/enable their “Edit Mode” button. This button is enabled by default. The namespace used in this event is the editor ID.

| Arguments | Description |
|---|---|
| Flag | A Boolean indicating whether to disable |
| | or to enable the EditMode button (“true” for |
| | disabling, “false” for enabling) |

Example: enable the editor's EditMode button:

EPCM.raiseEvent( “urn:com.sapportals.appdesigner:” + myEditorID,
“disableEditMode”, “false”);

Before the raising the disableSave event, disablePreview event, disableRefresh event, or disableEditMode event, an editor should make sure that the buttons component is already loaded. The editor can do this by subscribing to the “staticButtonsLoaded” event and/or the “allComponentsLoaded” event (see below).

updateTabCaption Event

This event is raised by any component who wants to ask the framework to change the title and tooltip of a specific open tab. The namespace used in this event is the framework's.

| Arguments | Description |
|---|---|
| editorID | The unique ID of the editor(tab) that is to be updated |
| newTabCaption | The new name that should appear as the tab title |
| newTabTooltip | The new string that should appear as the tab tooltip |

Example: Update a tab's name and tooltip:

EPCM.raiseEvent( “urn:com.sapportals.appdesigner:framework”,
“updateTabCaption”, myEditorID + “;newTabCaption;newTabTooltip”);

staticbuttonsloaded Event

This event is raised by the framework, to mark that the static buttons part of a specific tab loading is complete. The namespace used in this event is the editor ID. The event has no arguments. Example: An editor who wishes to get a notice when its buttons are loaded, should subscribe to the event in the following way:

EPCM.subscribeEvent( “urn:com.sapportals.appdesigner:” + myEditorID,
“staticButtonsLoaded”, staticButtonsLoadedHandler);

allComponentsLoaded Event

This event is raised by the framework, to mark that all frames in a specific tab loading is complete. The namespace used in this event is the editor ID. The event has no arguments. Example: An editor who wishes to get a notice when all the frames in its tab are loaded, should subscribe to the event in the following way:

EPCM.subscribeEvent( “urn:com.sapportals.appdesigner:” + myEditorID,
“allComponentsLoaded”, allComponentsLoadedHandler);

setFocus Event

This event is raised by the framework to signal the editor that it is now in focus. This is an optional event (in which an editor can issue timeout warnings to the user like “Lock timeout has exceeded. Would you like to refresh your lock so that it is editable again?”) or ask the user to refresh in case the open object has changed (see objectChanged event). The framework will raise those events to the editor itself and to the content catalog and hover menu so that they will be able to change their menus according to the editor currently in focus.

killFocus Event

This event is raised by the framework to signal the editor that it has lost focus. The namespace used in this event will be unique per editor instance (tab) and will contain the editor ID so that only one editor gets the event at a time. This is an optional event.

objectChanged Event

This event is raised by any of the open editors to notify a change that was submitted on an object. This is to allow other editors, opened with the same object to either refresh automatically or to notify the user and ask for instructions. This event should be subscribed and raised to the namespace of all components so that everyone can act upon a change.

| Arguments | Description |
|---|---|
| Object ID | The changed object's ID. |

Example:

EPCM.raiseEvent(“urn:com.sapportals.appdesigner:all”,
“/pcd/pages/page1”, “”);

registerLockedObject Event

This event is raised by the Editor to signal the framework that an object has been locked by the editor. The framework adds this object to the need-to-be-released list. If the user navigates out of the AD instance, the framework will try to release all the objects that are on the need-to-be-released list (using the general PCM API, or other methods).

| Arguments | Description |
|---|---|
| Object ID | The locked object's ID. |

Example:

EPCM.raiseEvent( ‘urn:com.sapportals.appdesigner:framework’,
‘registerLockedObject’, “pcd:portal_content/pages/page1”);

unregisterLockedObject Event

This event is raised by the Editor to signal the framework that the editor released an object lock and it can be removed from the need-to-be-released list.

| Arguments | Description |
|---|---|
| Object ID | The object's ID. |

Example

EPCM.raiseEvent( ‘urn:com.sapportals.appdesigner:framework’,
‘unregisterLockedObject’, “pcd:portal_content/pages/page1”);

### Content Catalog Events

addContentCatalogEvent Event

This event is raised by the different editors. Adds a new event which the user can launch on a content catalog object. Examples: “addToPage” for an iView, “showProperties” etc. Editors should use these events upon loading the first time to initialize the content catalog tasks available tasks.

| Arguments | Description |
|---|---|
| AddreserUniqueId | The unique id of the addresser, will be used to |
| | return an event with a unique namespace. |
| FriendlyName | To be presented to the user in the content catalog |
| | menus/buttons/right-click. |
| eventName | To be used by the content catalog to publish the user |
| | action. Should be unique per addresser. |
| Types | Type of objects on which the event can be invoked |

Example: The page editor will create an add to page event in the following way:

EPCM.raiseEvent( “urn:com.sapportals.appdesigner:contentCatalog “,
“addContentCatalogEvent”, “tab1;Assign to page;addToPage; iVu” );

After registering this event, the content catalog will display a task called “Assign to page” in its UI and allow the user to launch it on iViews only. Launching this task on iView8 would invoke the following event:

EPCM.raiseEvent( “urn:com.sapportals.appdesigner:tab1”, “addToPage”,
“/pcd/iViews/iVu8” );

removeContentCatalogEvent

Remove an event formerly published. Editors that close should remove their tasks.

| Arguments | Description |
|---|---|
| AddreserUniqueId | As formerly registered. |
| eventName | As formerly registered. |

disableContentCatalogEvent/enableContentCatalogEvent

Disable or enable an event formerly published. Should be used when an event should not be invoked momentarily. The editor may still be open but is currently not in a state to handle that specific task.

| Arguments | Description |
|---|---|
| AddreserUniqueId | As formely registered. |
| eventName | As formely registered. |

RefreshNode

Refresh the content under a parent node in the tree. Should be used by editors or wizards that made modifications that may affect the tree structure.

| Arguments | Description |
|---|---|
| nodeId | The node to be refreshed |

Wizard-Based Implementation

Aspects of the above system can be implemented using wizards. A wizard in the application designer forms a state machine of panes. Transitions between panes may be conditional. The panes contain input components for attributes to be collected by the wizard. There may be dependencies between panes or attributes.

The collected attributes and the state of the wizard's panes are kept in the wizard session. Attributes in the session may be accessed from any pane. Conditions imposed on transitions may be evaluated against the session. The final state of a wizard will typically create/change a repository object according to the attributes the wizard collected in the session.

The developer of a wizard writes panes that implement the IWizardComponent interface and define the set of transitions and dependencies between components using the framework API. The wizard framework will run the panes according to the rules defined by the transitions. The framework will handle the dependencies between the panes or subcomponents according to a transitive interpretation of the wizard's dependency rules.

Standard wizard components include a set of ready-for-use wizard components. These components handle their state and internal functionality independently. So that the wizard developer need only add components to the panes and set the Ids of the attributes collected. The collected attributes can then be accessible by their IDs in the wizard session.

Other Considerations

In the multi-editor environment, the application designer tabs are used for editing multiple objects simultaneously. Non-visible editors (editors that are not in the currently visible tab) do not hold any unsaved data and when navigating from tab to tab, the developer is prompted with a “save or cancel” dialog.

In some situations, more than one editor might need to be visible at a time (e.g., role editor, property editor, page editor and property editor open all at once), inside a tab. Two editors in the same tab may be open on the same object or on different objects, such as a page editor and property editor for the page and a page editor and property editor for an iView in the page. The designer can change the object in focus in the property editor without leaving the currently open tab (e.g., by navigating between different iViews in a page or different iViews and pages inside the role).

The editing of multiple objects in the property editor needs to be managed without violating the assumption that there is no hidden unsaved data. For example, suppose a page editor is open for page P and a property editor is open next to the page editor, showing P's properties. If a user edits some properties in the property editor then selects iView V (from within the page editor) for editing, a decision on saving P should be made and if not saved, there will be hidden unsaved data.

This issue is handled in some embodiments using a property editor with three modes: 1) open in read only, 2) open in edit mode with its own save button, and 3) open as a sub-editor and communicate through XML with the main editor. In the third case, saving and retrieval of data from the server is done in the main editor only and the property editor does not have a save button. When editing an object that is the same as the one edited in the main editor (e.g., role editor and property editor for the role), the property editor opens as sub-editor (mode 3). When editing an object that is different from the one edited in the main editor (e.g., page editor and property editor for an iView in the page), the property editor opens in read only mode (mode 1). It has an “edit” button that opens a new tab in which the object (iView) can be edited after saving or canceling the changes in the current tab (in the page editor). When editing an object for which the property editor is the main editor (for example, many iViews work this way), the editor is opened in edit mode (mode 2).

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. An interface for accessing objects in one or more object repositories, wherein objects are associated with nodes in an object hierarchy and have object types, the interface comprising:
a tree panel for displaying at least a portion of the object hierarchy;
an object panel for displaying an object interface, wherein at least one property of a current object is displayed;
an editor for each of a plurality of object types, each editor including instructions for displaying of an edit panel within the object panel when an edit function is selected; and
a permission hierarchy indicating which users of a class of users have access to which objects of the object hierarchy, wherein the tree panel display is dependent for each user on which objects the user has permission to view.

2. The interface of claim 1 further comprising a creation interface for creating additional instances of an object of the plurality of object types, wherein the creation interface is presented within the object panel when creating at least some of the object instances.

3. The interface of claim 1, wherein branches of the object hierarchy are associated with business functions, users are associated with the business functions and effective permissions for an object, including a view permission, are determined for a user based on the business functions associated with the branches of the object hierarchy to which the object belongs and the business functions with which the user is associated.

4. The interface of claim 3, wherein the business functions are marketing, sales, finance and operations.

5. The interface of claim 3, wherein the business functions represent a plurality of product divisions.

6. The interface of claim 3, wherein the business functions represent a plurality of independent corporate entities.
